(19) United States
(12) Patent Application Publication
(10) Pub. No.: US 2020/0279221 A1
(43) Pub. Date: Sep. 3, 2020

(54) INFORMATION PROCESSING SYSTEM AND INFORMATION PROCESSING METHOD

(71) Applicant: TOYOTA JIDOSHA KABUSHIKI KAISHA, Toyota-shi (JP)

(72) Inventors: Zekai QIU, Nisshin-shi (JP); Akie SAKIYAMA, Toyota-shi (JP); Yusuke TAKEUCHI, Miyoshi-shi (JP); Jun HIOKI, Nagakute-shi (JP); Shinji SASSA, Ama-shi (JP); Hiromitsu FUJII, Kariya-shi (JP); Keita TERUUCHI, Toyota-shi (JP)

(73) Assignee: TOYOTA JIDOSHA KABUSHIKI KAISHA, Toyota-shi (JP)

(21) Appl. No.: 16/794,339

(22) Filed: Feb. 19, 2020

(30) Foreign Application Priority Data
Feb. 28, 2019 (JP) 2019-036679

(51) Int. Cl. G06Q 10/08; B60L 53/66; B60L 53/30

(52) U.S. Cl. CPC G06Q 10/08355; B60L 53/305; B60L 53/665; G06Q 10/0833

(57) ABSTRACT

An information processing system includes a vehicle that delivers a package to a predetermined delivery destination, an in-house device installed inside a house at the predetermined delivery destination, the in-house device being capable of controlling an output device at the predetermined destination, and a processor configured to acquire position information of the vehicle, and to cause the in-house device to issue notification of approach of the vehicle through the output device, in a case where the vehicle approaches within a predetermined range of the predetermined delivery destination. The processor further causes the in-house device to issue notification of arrival of the vehicle through the output device, in a case where the vehicle arrives at the predetermined delivery destination.

### CROSS REFERENCE TO RELATED APPLICATION

This application claims the benefit of Japanese Patent Application No. 2019-036679, filed on Feb. 28, 2019, which is hereby incorporated by reference herein in its entirety.

### BACKGROUND

### Technical Field

The present disclosure relates to an information processing system and an information processing method.

### Description of the Related Art

Delivering a package to a delivery box at a delivery destination by an autonomous vehicle is proposed (for example, Patent document 1).

### CITATION LIST

### Patent Document

Patent document 1: Japanese Patent Laid-Open No. 2018-177439

One aspect of the disclosure is aimed at providing an information processing system and an information processing method enabling reduction of re-deliveries.

### SUMMARY

One aspect of the present disclosure is an information processing system including:

a vehicle that delivers a package to a predetermined delivery destination;

an in-house device installed inside a house at the predetermined delivery destination, the in-house device being capable of controlling an output device at the predetermined destination; and

a processor configured to:

acquire position information of the vehicle, and

cause the in-house device to issue notification of approach of the vehicle through the output device, in a case where the vehicle approaches within a predetermined range of the predetermined delivery destination.

Another aspect of the present disclosure is an information processing method including:

acquiring position information of a vehicle that delivers a package to a predetermined delivery destination; and

causing an in-house device, installed inside a house at the predetermined delivery destination and capable of controlling an output device at the predetermined delivery destination, to issue notification of approach of the vehicle through the output device, in a case where the vehicle approaches within a predetermined range of the predetermined delivery destination.

With the information processing system and the information processing method of the disclosure, re-deliveries may be reduced.

### BRIEF DESCRIPTION OF DRAWINGS

FIG. 1 is a diagram illustrating an example of a system configuration of a delivery system according to a first embodiment;

FIG. 2 is a diagram illustrating an example of a hardware configuration of a center server;

FIG. 3 is a diagram illustrating an example of a hardware configuration of a vehicle;

FIG. 4 is a diagram illustrating an example of a functional configuration of the center server and the vehicle;

FIG. 5 is an example of a vehicle information management table in the center server;

FIG. 6 is an example of a user information management table in the center server;

FIG. 7 is an example of a delivery information management table in the center server;

FIG. 8A is an example of a flowchart of a delivery notification process by the center server;

FIG. 8B is an example of a flowchart of the delivery notification process by the center server;

FIG. 9A is a diagram illustrating an example of a sequence of processes by the delivery system; and

FIG. 9B is a diagram illustrating an example of a sequence of processes by the delivery system.

### DESCRIPTION OF THE EMBODIMENTS

For example, there are cases where, even when a recipient of a package is at home, the recipient is not able to receive delivery of the package for some reason. In such a case, the recipient is assumed to be absent, and delivery of the package is performed again. Accordingly, a notification that a delivery vehicle is approaching is issued inside a house that is a delivery destination of a package, through an output device installed in the house, to allow a recipient to prepare for reception before arrival of the vehicle at the delivery destination, and to thereby reduce re-deliveries. Additionally, a preparation for reception of a delivery by a recipient does not have to be a specific action.

One aspect of the present disclosure is an information processing system including a vehicle that delivers a package to a predetermined delivery destination, an in-house device installed inside a house at the predetermined delivery destination, the in-house device being capable of controlling an output device at the predetermined destination, and a processor configured to acquire position information of the vehicle, and cause the in-house device to issue notification of approach of the vehicle through the output device, in a case where the vehicle approaches within a predetermined range of the predetermined delivery destination.

The in-house device that is installed inside a house at a delivery destination is a smart speaker, a control device of a home security system, a dedicated computer or the like, for example. The output device at the delivery destination is a speaker, a home electrical appliance, an intercom, or a smart speaker, for example. Home electrical appliances that can be used as the output device at the delivery destination in one aspect of the present disclosure include those with an audio output function, such as a TV, and those with an alarm function, such as a microwave oven, a washing machine, and a refrigerator, for example. The predetermined range of a predetermined delivery destination with respect to which a notification of approach of the vehicle is issued is a range of a predetermined distance, a range in which radio waves for predetermined wireless communication may be received, or the like, for example.

According to one aspect of the present disclosure, when a vehicle delivering a package approaches within the predetermined range, a notification of approach of the vehicle is issued inside a house at the delivery destination, and a recipient of the package at the delivery destination may prepare for reception of the package. For example, when the notification of approach of the delivery vehicle is issued, the recipient may delay going out or may temporarily stop chores, and a state where the recipient may receive the package is achieved, and thus, re-deliveries may be reduced.

Furthermore, in one aspect of the present disclosure, the processor may further cause the in-house device to issue notification of arrival of the vehicle through the output device, in a case where the vehicle arrives at the predetermined delivery destination. Due to approach of the vehicle being notified in two stages, also at the time of arrival of the vehicle at the predetermined delivery destination, the recipient may be enabled to get prepared according to approach of the vehicle.

Furthermore, in one aspect of the present disclosure, the vehicle may be an electric vehicle, and the vehicle may start charging from a power supply device provided at the predetermined delivery destination, in a case where handing over of the package is not performed even after a lapse of a predetermined time after arrival of the vehicle at the predetermined delivery destination. This allows a wait time until the package is handed over to be effectively used. A timing of arrival of the vehicle at the delivery destination as a timing of start of measurement of the predetermined time used as a trigger to start charging may be a timing when the vehicle is detected, on the basis of position information, to have actually arrived at the delivery destination, or a timing when the in-house device is instructed to cause the output device to issue notification of arrival of the vehicle.

Furthermore, in such a case, the processor may give a predetermined incentive to a user associated with the predetermined delivery destination, after charging of the vehicle is ended. The user may thereby be encouraged to allow charging of the vehicle by the power supply device at the delivery destination.

An aspect of the present disclosure may be grasped in relation to an information processing method. The information processing method includes acquiring position information of a vehicle that delivers a package to a predetermined delivery destination, and causing an in-house device, installed inside a house at the predetermined delivery destination and capable of controlling an output device at the predetermined delivery destination, to issue notification of approach of the vehicle through the output device, in a case where the vehicle approaches within a predetermined range of the predetermined delivery destination. Additionally, a technical idea disclosed in relation to the information processing system described above may be applied to the information processing method to the extent that no technical conflict exists.

In the following, an embodiment of the present disclosure will be described with reference to the drawings. The configuration of the embodiment described below is an example, and the present disclosure is not limited to the configuration of the embodiment.

### First Embodiment

<System Overview>

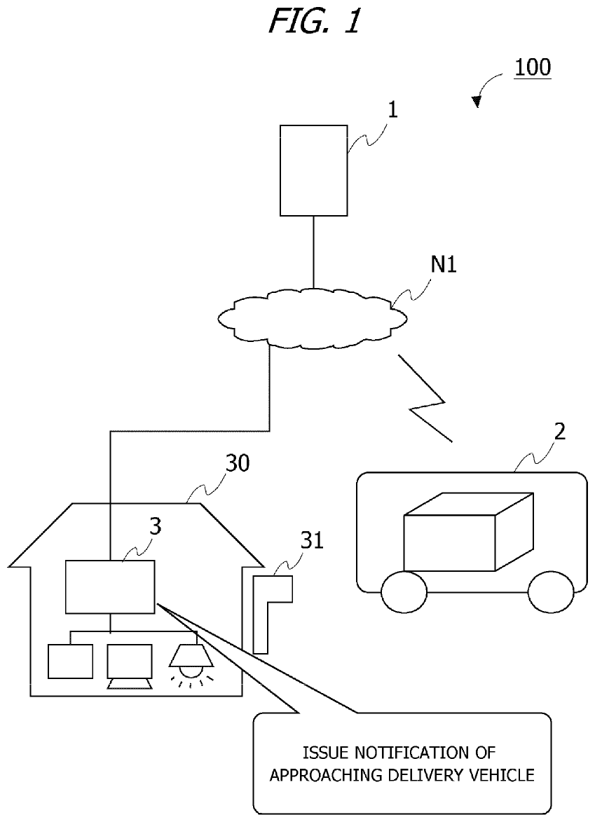

FIG. 1 is a diagram illustrating an example of a system configuration of a delivery system 100 according to a first embodiment. The delivery system 100 is a system according to which, when a delivery vehicle approaches a delivery destination, a notification regarding approach of the delivery vehicle is performed at the delivery destination through an in-house device at the delivery destination, for example. The delivery system 100 includes a center server 1, a vehicle 2, and an in-house device 3. The delivery system 100 is an example of the “information processing system”.

For example, the vehicle 2 is an electric vehicle that is capable of autonomous driving and unmanned driving. In the first embodiment, the vehicle 2 is a vehicle that delivers a package to a predetermined delivery destination. The delivery system 100 includes a plurality of vehicles 2, however in FIG. 1, only one vehicle 2 is illustrated for the sake of convenience. For example, the vehicle 2 is connected to a network N1 through a wireless communication network, and is connected to the center server 1 through the network N1. The vehicle 2 performs mobile communication according to 3rd generation (3G), Long Term Evolution (LTE), LTE-Advanced or 5th generation (5G), or wireless communication according to wireless LAN standards such as WiFi. The network N1 is the Internet, for example.

The vehicle 2 creates an operation plan upon reception of an operation command from the center server 1, and performs autonomous driving to a destination according to the operation plan. The vehicle 2 includes position information acquisition means, and acquires and transmits position information to the center server 1 every predetermined period.

The in-house device 3 is installed inside a house 30 of a user for whom a wish to receive a service, provided by the delivery system 100, of issuing notification of approach of a delivery vehicle is registered in advance, and is a device capable of controlling another output device that is connected to a network in the house, through the network in the house. For example, the in-house device 3 is a smart speaker, a dedicated computer, a control device of a home security system, or the like. Furthermore, the output device to be connected to the network inside the house is a device including at least one of an audio output function or a display function, such as a TV, a microwave oven, a refrigerator, a speaker, a washing machine or the like, and such devices are set to be controllable by the in-house device 3. The delivery system 100 may include a plurality of in-house devices 3 registered in advance by each user wishing to receive the service provided by the delivery system 100, but FIG. 1 illustrates only one in-house device 3 for the sake of convenience.

In the first embodiment, the vehicle 2 delivers a package by receiving a delivery request from the center server 1. The vehicle 2 transmits position information to the center server 1 every predetermined period, and a position of the vehicle 2 is thereby grasped by the center server 1. For example, in a case of detecting that the vehicle 2 approached within a predetermined range of a delivery destination, the center server 1 transmits a notification instruction regarding a delivery vehicle approach notification to the in-house device 3 that is associated with the delivery destination. When the notification instruction regarding the delivery vehicle approach notification is received from the center server 1, the in-house device 3 causes the notification regarding approach of the delivery vehicle to be output from an output device inside the house. The delivery vehicle approach notification may be a voice message or may simply be an alarm sound. An output device including a display function may display a message in the form of a text or an image indicating that the delivery vehicle is approaching.

When the delivery destination is notified of approach of the delivery vehicle of a package in such a manner, a recipient may prepare to receive the package even if the recipient is in the middle of performing a task, by temporarily stopping or cutting short the task, for example. Accordingly, occurrence of re-delivery due to a recipient not being able to receive a package even though he/she is at home may be suppressed.

Furthermore, in the first embodiment, in the case of detecting that the package is not handed over after a lapse of a predetermined time after arrival of the vehicle 2 at the delivery destination, the center server 1 instructs the vehicle 2 to perform charging from a power supply device 31 that is provided at the house 30 of the recipient at the delivery destination. The vehicle 2 receives the instruction from the center server 1, and starts charging from the power supply device 31. Such charging is continued until a lapse of a predetermined time or until handing over of the package is completed. Furthermore, an incentive is given to the user at the delivery destination according to an electricity fee for charging the vehicle 2. The incentive to be given to the user at the delivery destination may be points, a coupon or the like that can be used in the delivery system 100 or other systems, for example.

The time of waiting for the recipient of a package at the delivery destination may be thus effectively used, and also, the vehicle 2, which is an electric vehicle, may be enabled to operate longer.

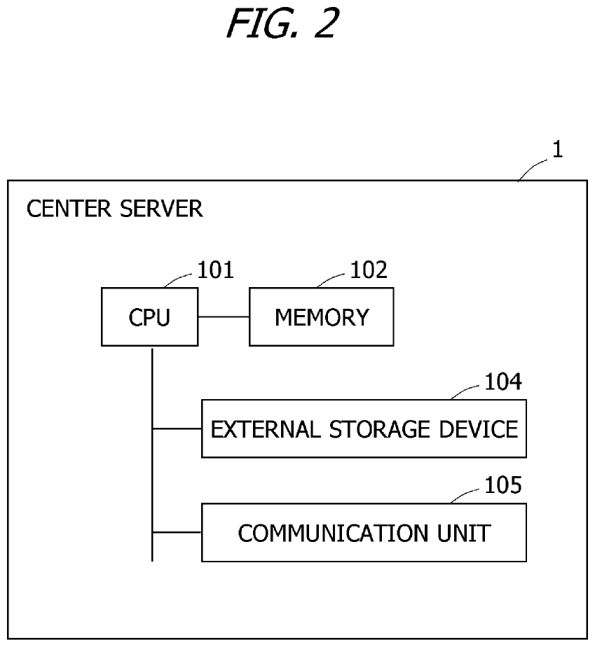

FIG. 2 is a diagram illustrating an example of a hardware configuration of the center server 1. The center server 1 includes a CPU 101, a memory 102, an external storage device 104, and a communication unit 105. The CPU 101 executes computer programs that are executably developed in the memory 102, and performs processes as the center server 1.

The memory 102 stores computer programs to be executed by the CPU 101, data to be processed by the CPU 101, and the like. For example, the memory 102 is a dynamic random access memory (DRAM), a static random access memory (SRAM), a read only memory (ROM) or the like. The external storage device 104 is a non-volatile storage, and is a solid state drive (SSD), a hard disk drive or the like, for example.

For example, the communication unit 105 communicates with various servers on the network N1, the vehicle 2, the in-house device 3 and the like through a public communication network by connecting to the public communication network through a LAN. Additionally, the hardware configuration of the center server 1 is not limited to the one illustrated in FIG. 2, and addition or substitution may be appropriately performed according to the embodiment.

Additionally, like the center server 1, the in-house device 3 includes a CPU, a memory, an external storage device, and a communication unit, but illustration thereof is omitted. In the case where the in-house device 3 is a smart speaker, a speaker is also provided in addition to the above. Furthermore, the in-house device 3 may also include a display device without being limited to above components.

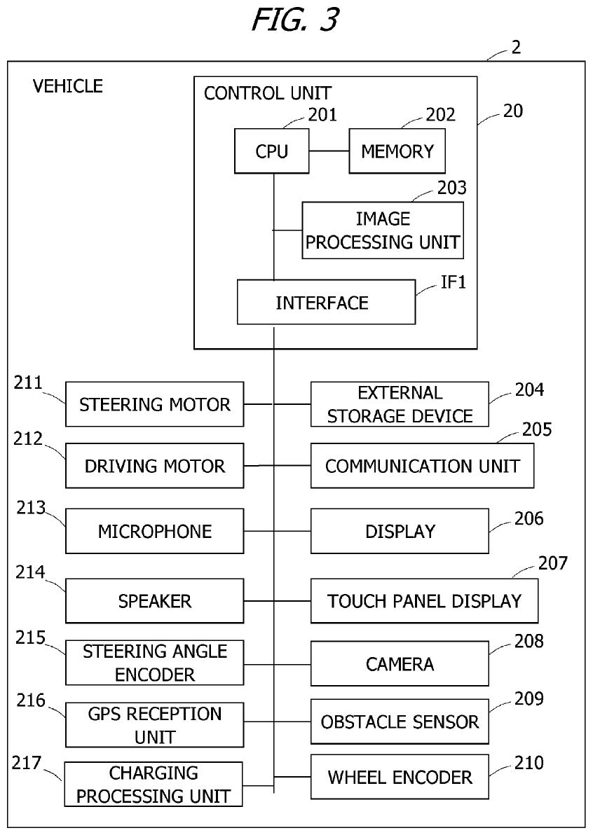

FIG. 3 is a diagram illustrating an example of a hardware configuration of the vehicle 2. In FIG. 3, a description is given assuming that the vehicle 2 is an electric vehicle that is capable of autonomous driving. Additionally, FIG. 3 extracts and illustrates hardware related to a control system.

The vehicle 2 includes a control unit 20, an external storage device 204, a communication unit 205, a display 206, a display 207 with a touch panel, a camera 208, an obstacle sensor 209, a wheel encoder 210, a steering motor 211, a driving motor 212, a microphone 213, a speaker 214, a steering angle encoder 215, a global positioning system (GPS) reception unit 216, and a charging processing unit 217.

The control unit 20 is also referred to as an electronic control unit (ECU). The control unit 20 includes a CPU 201, a memory 202, an image processing unit 203, and an interface IF1. The external storage device 204, the communication unit 205, the display 206, the display 207 with a touch panel, the camera 208, the obstacle sensor 209, the wheel encoder 210, the steering motor 211, the driving motor 212, the microphone 213, the speaker 214, the steering angle encoder 215, the GPS reception unit 216, and the charging processing unit 217 are connected to the interface IF1.

The obstacle sensor 209 is an ultrasonic sensor, a radar or the like. The obstacle sensor 209 emits an ultrasonic wave, an electromagnetic wave or the like in a detection target direction, and detects presence, a position, a relative speed or the like of an obstacle in the detection target direction on the basis of a reflected wave. The obstacle may be a pedestrian, a bicycle, a structure, a building or the like, for example. In the case where the vehicle 2 has a box-shaped body, for example, a plurality of obstacle sensors 209 are provided, and the plurality of obstacle sensors 209 are provided at positions near four corners at the front, back, left and right of the vehicle 2, respectively. Additionally, the front, back, left and right of the vehicle 2 are determined according to a traveling direction, for example.

The camera 208 is an image capturing device using an image sensor such as a charge-coupled device (CCD), a metal-oxide-semiconductor (MOS), a complementary metal-oxide-semiconductor (CMOS) or the like. The camera 208 acquires an image at a predetermined time interval called frame period, and stores the image in a frame buffer in the control unit 20. A plurality of cameras 208 are provided on the vehicle 2, and the plurality of cameras 208 are installed on respective ones of front, back, left and right side surfaces of the vehicle 2 while facing outward, for example. However, such a case is not restrictive, and some cameras 208 may be installed facing the inside of the vehicle.

The steering motor 211 controls an angle of a direction of a cross line at which a plane of rotation of a wheel and a horizontal plane intersect, or in other words, a traveling direction by rotation of the wheel, according to an instruction signal from the control unit 20. The driving motor 212 drives and rotates each of four wheels provided on the vehicle 2, for example, according to an instruction signal from the control unit 20. Alternatively, the driving motor 212 may drive one pair of wheels, of two pairs of front wheels and rear wheels.

The steering angle encoder 215 detects a steering angle indicating a traveling direction of a wheel at a predetermined detection time interval, and stores the steering angle in a register of the control unit 20. The steering angle is an angle of a rotation shaft of the wheel in the horizontal plane. For example, an origin of the angle is set in a direction at which the rotation shaft of the wheel is orthogonal to the traveling direction of the vehicle 2. Furthermore, the wheel encoder 210 acquires a rotation angle of the wheel at a predetermined detection time interval, and stores the rotation angle in the register of the control unit 20.

For example, the communication unit 205 is a communication unit for communicating with various servers and the like on a network through a public communication network connected to WiFi access points or mobile phone base stations, by connecting to the WiFi access points or the mobile phone base stations. The communication unit 205 performs wireless communication by wireless signals and a wireless communication method according to a predetermined wireless communication standard.

The GPS reception unit 216 receives time signal radio waves from a plurality of global positioning satellites orbiting the Earth, and stores the time signal in the register of the control unit 20. The microphone 213 detects audio, converts the audio into a digital signal, and stores the digital signal in the register of the control unit 20. The speaker 214 is driven by a D/A converter and an amplifier connected to a signal processing unit or the control unit 20, and reproduces audio including sound and voice. The microphone 213 and the speaker 214 may each include one that is provided facing the inside of the vehicle 2 and one that is provided facing the outside of the vehicle 2.

For example, the charging processing unit 217 is a power reception module of a wireless power supply system, an attachment plug and a control mechanism for insertion/removal of the attachment plug with respect to a socket, or the like. The charging processing unit 217 charges power in the vehicle 2.

For example, the display 206 is provided on each side surface of the body of the vehicle 2 in a manner facing the outside of the vehicle 2. The display 206 is a liquid crystal display, an electro-luminescence panel or the like, for example. The display 207 with a touch panel is an input device for an instruction from a user, and is installed facing the inside of the vehicle 2, for example. However, such a case is not restrictive, and the display 207 with a touch panel may be installed near a door of the vehicle 2 in a manner facing the outside, for example.

The CPU 201 of the control unit 20 executes a computer program that is executably developed in the memory 202, and performs a process as the control unit 20. The memory 202 stores computer programs to be executed by the CPU 201, data to be processed by the CPU 201, and the like. For example, the memory 202 is a dynamic random access memory (DRAM), a static random access memory (SRAM), a read only memory (ROM), or the like. The image processing unit 203 processes data in the frame buffer obtained from the camera 208 every predetermined frame period, in coordination with the CPU 201. For example, the image processing unit 203 includes a GPU and an image memory as the frame buffer. The external storage device 204 is a non-volatile storage, and is a solid state drive (SSD), a hard disk drive or the like, for example.

For example, the control unit 20 acquires a detection signal from a sensor of each unit of the vehicle 2, via the interface IF1. Furthermore, the control unit 20 calculates a latitude and a longitude indicating a position on the Earth, from a detection signal from the GPS reception unit 216. Moreover, the control unit 20 acquires map data from a map information database stored in the external storage device 204, checks the calculated latitude and longitude against a position on the map data, and determines a current position. Furthermore, the control unit 20 acquires a route from the current position to a destination on the map data. Moreover, the control unit 20 detects an obstacle around the vehicle 2 on the basis of a signal from the obstacle sensor 209, the camera 208 or the like, determines the traveling direction such that the obstacle is avoided, and controls the steering angle.

Furthermore, the control unit 20 processes an image acquired from the camera 208 on a per-frame data basis, in coordination with the image processing unit 203, and detects a change on the basis of a difference between images and recognizes an obstacle, for example. Additionally, the control unit 20 may transmit frame data of an image from the camera 208 and audio data obtained from the microphone 213, from the communication unit 205 to the center server 1 on the network. Then, analysis of the frame data of the image and the audio data may be assigned to the center server 1.

Still further, the control unit 20 causes images, texts, and other information pieces to be displayed on the display 206. Furthermore, the control unit 20 detects an operation on the display 207 with a touch panel, and receives an instruction from a user.

FIG. 3 illustrates the interface IF1 as an example, but exchange of signals between the control unit 20 and a control target is not limited to be performed through the interface IF1. That is, the control unit 20 may include a plurality of signal exchange paths other than the interface IF1. Furthermore, in FIG. 3, the control unit 20 includes a single CPU 201. However, the CPU is not limited to a single processor, and may adopt a multiprocessor configuration. Alternatively, a single CPU connected by a single socket may have a multicore configuration. At least a part of processes of the above-described units may be performed by a processor other than the CPU, such as a dedicated processor such as a digital signal processor (DSP) or a graphics processing unit (GPU). At least a part of processes of the above-described units may be an integrated circuit (IC) or another digital circuit. An analog circuit may be included in at least a part of the above-described units.

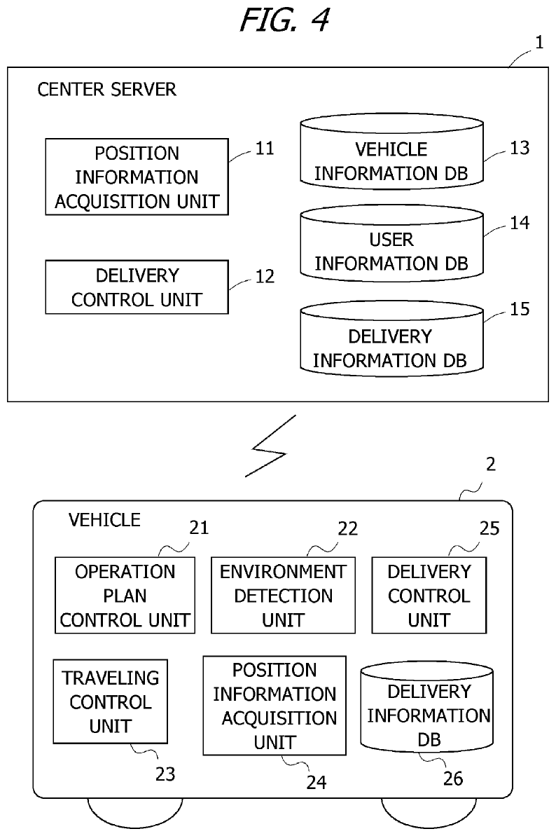

FIG. 4 is a diagram illustrating an example of a functional configuration of the center server 1 and the vehicle 2. The center server 1 operates as each unit illustrated in FIG. 4 by computer programs in the memory 102. For example, the center server 1 includes, as functional structural elements, a position information acquisition unit 11, a delivery control unit 12, a vehicle information database (DB) 13, a user information DB 14, and a delivery information DB 15.

The position information acquisition unit 11 acquires the position information of the vehicle 2 transmitted from the vehicle 2 every predetermined period, and updates the position information of the vehicle 2 stored in the vehicle information DB 13 described later.

The delivery control unit 12 controls delivery of a package by the vehicle 2. More specifically, the delivery control unit 12 transmits, to the vehicle 2, an operation command as a delivery request. Furthermore, the delivery control unit 12 performs a delivery notification process. The delivery notification process is a process of monitoring the position information of the vehicle 2 during delivery, of issuing a notification regarding approach of the delivery vehicle at a timing when the vehicle 2 approaches the delivery destination, and of issuing a notification regarding arrival of the delivery vehicle at a timing of arrival.

Specifically, in a case of detecting that the vehicle 2 approached within a predetermined range of the delivery destination of a package, the delivery control unit 12 transmits a notification instruction regarding a delivery vehicle approach notification to the in-house device 3 at the delivery destination. The predetermined range is a range of a predetermined distance of the delivery destination, or a range in which communication with the in-house device 3 at the delivery destination by a predetermined wireless communication method may be performed, for example. Furthermore, the predetermined range is a range in which the vehicle 2 may arrive at the delivery destination within a predetermined time at a predetermined speed, for example.

Furthermore, in a case of detecting arrival of the vehicle 2 at the delivery destination, the delivery control unit 12 transmits a notification instruction regarding a delivery vehicle arrival notification to the in-house device 3 at the delivery destination. For example, in a case where a notification regarding delivery completion is received from the vehicle 2, the delivery control unit 12 determines that the delivery is completed. For example, instruction to the in-house device 3 is performed by transmission of an email or through push distribution, although not limited thereto.

Moreover, the delivery control unit 12 transmits an instruction to the vehicle 2 to start charging, in a case where the notification regarding delivery completion is not received from the vehicle 2 even after a lapse of a predetermined time after transmission of the notification instruction regarding the delivery vehicle arrival notification to the in-house device 3, for example. The predetermined time from transmission of the notification instruction regarding the delivery vehicle arrival notification to the in-house device 3 to transmission to the vehicle 2 of the instruction to start charging is arbitrarily set between 3 and 10 minutes by an administrator of the delivery system 100, for example. Furthermore, measurement of the predetermined time may be started with detection of arrival of the delivery vehicle at the arrival destination as a trigger, instead of transmission of the notification instruction regarding the delivery vehicle arrival notification to the in-house device 3.

In a case where the notification regarding delivery completion is received from the vehicle 2, or where a predetermined time further has elapsed, after transmission of the instruction to start charging, the delivery control unit 12 transmits an instruction to the vehicle 2 to stop charging. The predetermined time from transmission of the instruction to start charging to transmission of the instruction to stop charging is arbitrarily set between 10 and 30 minutes by the administrator of the delivery system 100, for example.

For example, the delivery control unit 12 determines the electricity fee for charging from the time taken to perform the charging, and gives a user at the delivery destination an incentive according to the electricity fee. The time taken for charging or the amount of charge may be received from the vehicle 2, or the time from the instruction to start charging to the instruction to stop charging may be taken as the charging time, for example. The incentive to be given to a user is points, a coupon or the like that can be used in the delivery system 100 or another coordinating system.

The vehicle information DB 13, the user information DB 14, and the delivery information DB 15 are created in a memory area of the external storage device 104 of the center server 1, for example. The vehicle information DB 13, the user information DB 14, and the delivery information DB 15 are relational databases, for example. The vehicle information DB 13 stores information about the vehicle 2. The user information DB 14 stores information about a user wishing to receive a service provided by the delivery system 100. The delivery information DB 15 stores information about a delivery. Details of information stored in each of the DBs will be given later.

Any one of the functional structural elements of the center server 1, or a part of the processes thereof may be implemented by another computer that is connected to the network. Furthermore, a series of processes to be performed by the center server 1 may be performed by hardware or by software.

The vehicle 2 operates as each unit illustrated in FIG. 4 by computer programs in the memory 202. For example, the vehicle 2 includes, as functional structural elements, an operation plan control unit 21, an environment detection unit 22, a traveling control unit 23, a position information acquisition unit 24, a delivery control unit 25, and a delivery information DB 26.

For example, the position information acquisition unit 24 acquires, every predetermined period, the position information of the vehicle 2 that is acquired by the GPS reception unit 216 or the like, and transmits the position information to the center server 1. The position information of the vehicle 2 is latitude and longitude, for example. Alternatively, the position information of the vehicle 2 may be an address, for example. Moreover, the position information of the vehicle 2 that is acquired by the position information acquisition unit 24 is output to the operation plan control unit 21 and the traveling control unit 23, for example. Additionally, identification information of the vehicle 2 is also transmitted together with the position information, other notifications and the like that are transmitted from the vehicle 2.

The operation plan control unit 21 receives an operation command from the center server 1. Delivery information is also received together with the operation command. The delivery information that is received from the center server 1 includes identification information of a delivery, information about a delivery destination, information about a delivery target package, information about a scheduled delivery time, and the like, for example. The operation plan control unit 21 stores the received delivery information in the delivery information DB 26.

In a case where there is a plurality of delivery target packages, the operation plan control unit 21 determines a delivery order on the basis of the operation command and the delivery information, for example. The delivery order is determined for each time slot on the basis of information about the delivery destinations of packages scheduled to be delivered, for example. In a case where a delivery request is newly received, or in a case where a time that is a predetermined time before a start time of one scheduled delivery time slot is reached, for example, the operation plan control unit 21 creates an operation plan by calculating a route that runs along the delivery destinations of the packages scheduled to be delivered.

The operation plan includes data about the route where the vehicle 2 is to travel that is calculated in the above manner, and data specifying processes to be performed by the vehicle 2 at a part of the route or along the entire route. An example of the processes to be performed by the vehicle 2 is handing over of a package at a delivery destination. The operation plan control unit 21 outputs the created operation plan to the traveling control unit 23. The operation plan control unit 21 may also transmit the created operation plan to the center server 1.

The environment detection unit 22 detects ambient environment information of the vehicle 2 to be used for autonomous driving, on the basis of data acquired by various sensors installed in the vehicle 2. Detection targets of the environment detection unit 22 are, but not limited to, the number and positions of lanes, the number and positions of vehicles that are present in the periphery of the vehicle in question, the number and positions of obstacles (such as pedestrians, bicycles, structures, buildings, etc.) that are present in the periphery of the vehicle in question, a structure of a road, a road sign and the like. The detection targets may be anything as long as they are used to perform autonomous driving. For example, in a case where the sensor is a stereo camera, detection of an object in the periphery of the vehicle 2 is performed by subjecting image data captured by the stereo camera to image processing. Data about the ambient environment of the vehicle 2 detected by the environment detection unit 22 is output to the traveling control unit 23 described later.

For example, the traveling control unit 23 creates a control command for controlling autonomous driving of the vehicle in question, on the basis of the operation plan created by the operation plan control unit 21, data about the ambient environment of the vehicle 2 created by the environment detection unit 22, and the position information of the vehicle in question acquired by the position information acquisition unit 24. For example, when an operation plan is input from the operation plan control unit 21, the traveling control unit 23 secures safety of movement by determining whether there is an obstacle in a moving direction indicated by the operation plan. In the case where it is determined that there is no obstacle in the moving direction, the traveling control unit 23 creates a control command to cause the vehicle in question to travel along the route according to the operation plan. The created control command is transmitted to the driving motor 212. A known method may be adopted as the method for creating the control command for causing a vehicle to perform autonomous driving.

The delivery control unit 25 controls a delivery that the vehicle 2 is requested by the center server 1 to perform. Specifically, the delivery control unit 25 performs loading of a package, handing over of the package, and a charging process at the delivery destination. With respect to loading of a package and handing over of the package, when a package is loaded or is handed over, a staff member who loaded the package or a recipient may input a notification regarding loading completion or delivery completion via the display 207 with a touch panel of the vehicle 2. When loading completion or delivery completion is input by the staff member or the recipient, the delivery control unit 25 transmits the same to the center server 1.

When the instruction to start charging is received from the center server 1, the delivery control unit 25 starts charging from the power supply device 31 that is installed at the delivery destination. For example, in a case where the charging processing unit 217 is a power reception module for wireless power supply, and the power supply device 31 is a power transmission module, the delivery control unit 25 analyzes a captured image of the camera 208 and detects the power supply device 31, and adjusts the position of the charging processing unit 217 such that power can be received from the power supply device 31, for example. Alternatively, in a case where the charging processing unit 217 is an attachment plug and a mechanism for insertion/removal of the attachment plug with respect to a socket, and the power supply device 31 is the socket, the delivery control unit 25 analyzes a captured image of the camera 208 and detects the power supply device 31, and inserts the attachment plug of the charging processing unit 217 in the power supply device 31, for example.

Furthermore, when the instruction to stop charging is received from the center server 1, the delivery control unit 25 stops charging. The process of stopping charging includes storing the charging processing unit 217 in an original position, for example. Moreover, the delivery control unit 25 may transmit the charging time or the amount of charge to the center server 1.

The delivery information DB 26 is created in a memory area of the external storage device 204 of the vehicle 2, for example. The delivery information DB 26 is a relational database, for example. The delivery information DB 26 stores information about a delivery.

Any of the functional structural elements of the vehicle 2 or a part of the processes thereof may be implemented by another computer that is connected to the network. Furthermore, a series of processes to be performed by the vehicle 2 may be performed by hardware or by software.

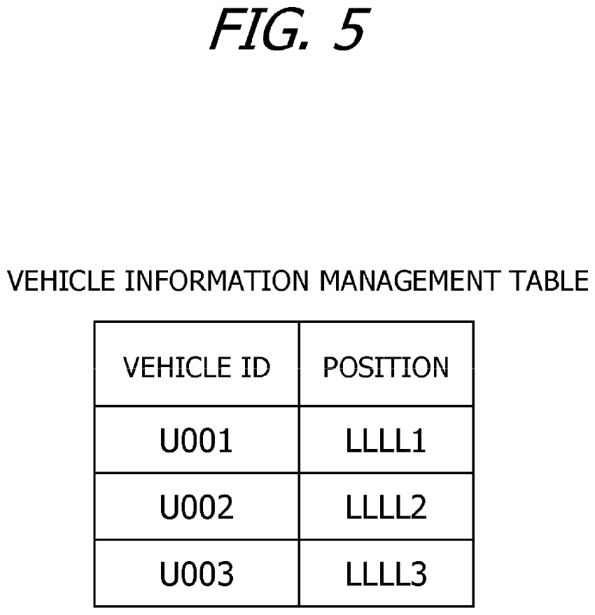

FIG. 5 is an example of a vehicle information management table in the center server 1. The vehicle information management table is stored in the vehicle information DB 13. Information about the vehicle 2 is stored in the vehicle information management table. In the example illustrated in FIG. 5, fields of vehicle ID and position are included in the vehicle information management table.

In the field of vehicle ID, identification information of the vehicle 2 is stored. In the field of position, position information of the vehicle 2 is stored. The position information of the vehicle 2 is received from the vehicle 2 every predetermined period. The field of the position of the vehicle 2 in the vehicle information management table is updated by the position information acquisition unit 11 every time the position information is received from the vehicle 2.

Additionally, information pieces to be held in the vehicle information management table are not limited to those illustrated in FIG. 5, and addition may be made as appropriate according to the embodiment.

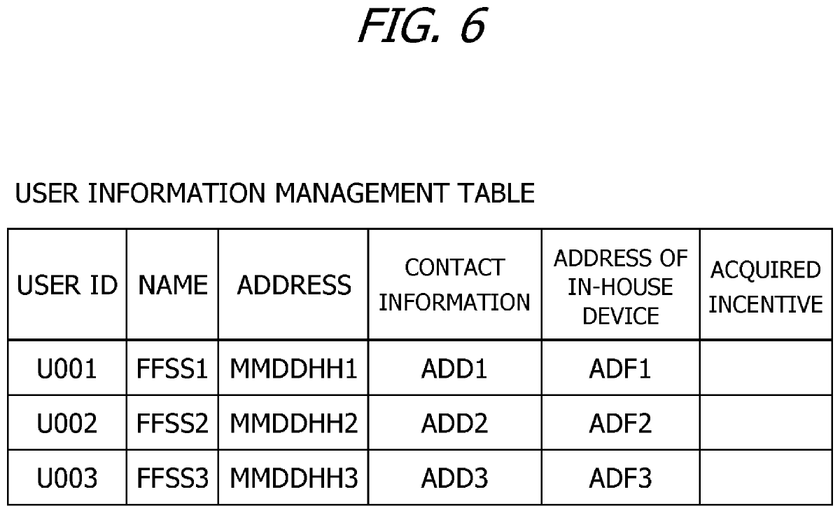

FIG. 6 is an example of a user information management table in the center server 1. The user information management table is stored in the user information DB 14. Information about a user wishing to receive a service provided by the delivery system 100 is stored in the user information management table. In the first embodiment, a user wishing to receive a service provided by the delivery system 100 is a user who receives a notification of approach of the vehicle 2 delivering a package and who is possibly to receive the package.

Fields of user ID, name, address, contact information, contact information of in-house device, and acquired incentive are included in the user information management table illustrated in FIG. 6. In the field of user ID, identification information of a user is stored. In the field of name, the name of the user is stored. In the field of address, the address of the user is stored. The address of the user is possibly the address of the delivery destination. In the field of contact information, the telephone number, email address or the like of the user is stored, for example.

In the field of contact information of in-house device, an email address or identification information of the in-house device 3 used in push distribution, or the like is stored as contact information of the in-house device installed at home of the user, for example. Various instructions from the center server 1 to the in-house device 3 are transmitted using the information stored in the field of contact information of in-house device.

In the field of acquired incentive, information about an incentive that is already acquired by the user is stored. Additionally, information pieces to be held in the user information management table are not limited to those illustrated in FIG. 6, and may be changed as appropriate according to the embodiment.

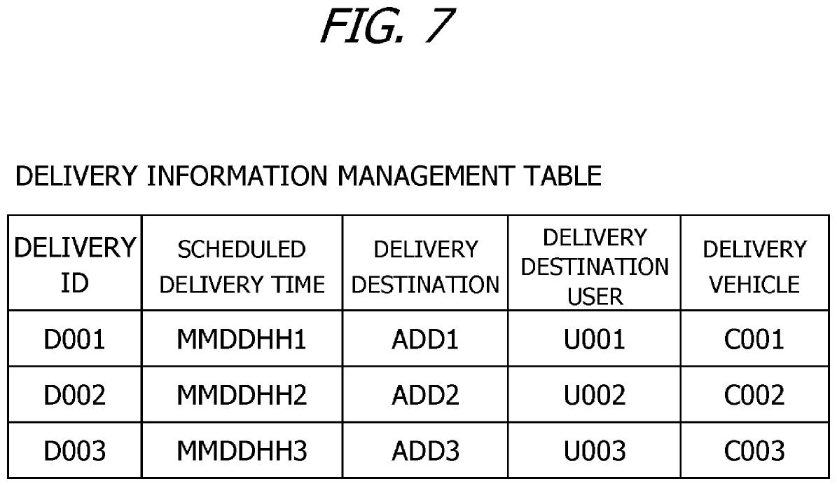

FIG. 7 is an example of a delivery information management table in the center server 1. The delivery information management table is stored in the delivery information DB 15. The delivery information management table is a table holding information about a delivery. In the example illustrated in FIG. 7, the delivery information management table includes fields of delivery ID, scheduled delivery time, delivery destination, delivery destination user, and delivery vehicle.

In the field of delivery ID, identification information of a delivery is stored. In the field of scheduled delivery time, information about a scheduled delivery time slot is stored. For example, in the case where a desired delivery time slot is specified at the time of a delivery request, the time slot is stored. For example, in the case where a desired delivery time slot is not specified at the time of a delivery request, the field is empty, or in the case where a scheduled delivery time slot that the vehicle 2 performing the delivery is to issue notification of is notified, the scheduled delivery time slot is stored.

In the delivery destination, the address of the delivery target is stored. Identification information of a user who is registered in the user information management table, and who corresponds to the address stored in the field of delivery destination is stored in the field of delivery destination user. In the case where an address corresponding to the address that is stored in the field of delivery destination is not registered in the user information management table, the field of delivery destination user is empty, and the service of issuing notification of approach of a delivery vehicle is not conducted. In the field of delivery vehicle, identification information of the vehicle 2 that is assigned with delivery is stored.

The delivery information management table is managed by the delivery control unit 12. Registration in the fields of delivery ID, scheduled delivery time, and delivery destination are performed when a delivery request is input, for example. Identification information of a user corresponding to the address that is stored in the field of delivery destination is acquired from the user information management table, and is input in the field of delivery destination user, for example. A value is input in the field of delivery vehicle when the delivery vehicle is determined by the center server 1.

Additionally, information pieces to be held in the delivery information management table are not limited to those illustrated in FIG. 7, and may be changed as appropriate according to the embodiment. Furthermore, information pieces for which the vehicle 2 is the delivery vehicle, among information pieces held in the delivery information management table illustrated in FIG. 7, are held in the delivery information DB 26 that is held in the vehicle 2, for example.

<Flow of Processes>

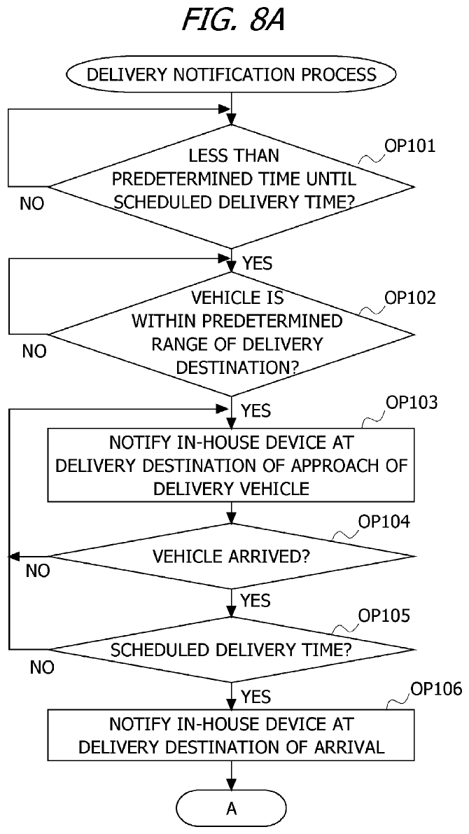

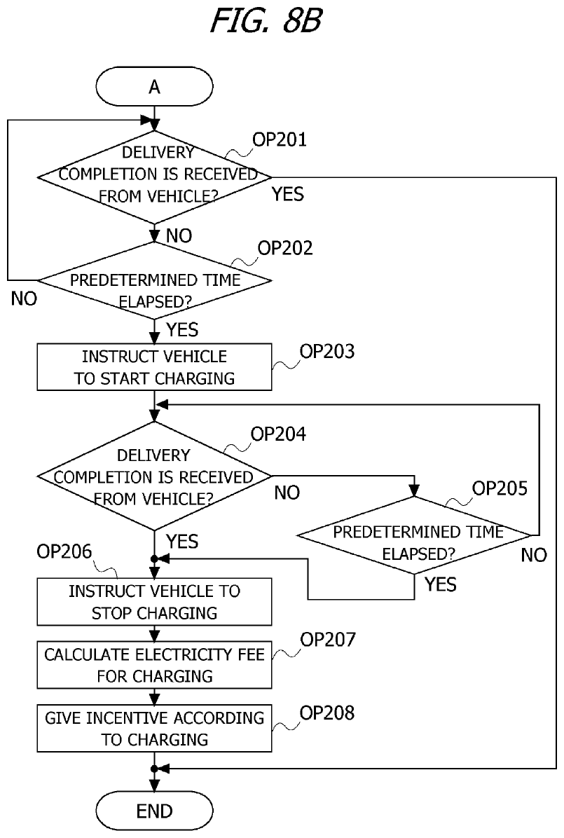

FIGS. 8A and 8B are examples of a flowchart of the delivery notification process by the center server 1. The processes illustrated in FIGS. 8A and 8B are started when a predetermined time before a scheduled delivery time of the vehicle 2 is reached with respect to one delivery, for example. In the case where the scheduled delivery time is specified by a time slot, the processes are started when a predetermined time before the start time of the time slot is reached. However, such a case is not restrictive, and a trigger for starting the processes illustrated in FIGS. 8A and 8B may be detection of start of a delivery by the vehicle 2, for example. The processes illustrated in FIGS. 8A and 8B are performed by the CPU 101 of the center server 1, but a description will be given taking a functional structural element as a performer, for the sake of convenience.

In OP101, the delivery control unit 12 determines whether a time until the scheduled delivery time for a target delivery in the delivery information management table is less than a predetermined time. The scheduled delivery time may be a scheduled delivery time slot or a scheduled delivery time point. In the case where the time until the scheduled delivery time for the target delivery is less than the predetermined time (OP101: YES), the process proceeds to OP102. In the case where the time until the scheduled delivery time for the target delivery is equal to or greater than the predetermined time (OP101: NO), the process in OP101 is repeated until the time until the scheduled delivery time for the target delivery falls below the predetermined time.

In OP102, the delivery control unit 12 determines whether the vehicle 2 is present within a predetermined range of the delivery destination, on the basis of the position information of the vehicle 2. Information about the vehicle 2 performing the target delivery and the delivery destination are acquired from the delivery information management table (FIG. 7), for example. The position information of the vehicle 2 is acquired from the vehicle information table (FIG. 5), for example.

In the case where the vehicle 2 is present within the predetermined range of the delivery destination (OP102: YES), the process proceeds to OP103. In the case where the vehicle 2 is not present within the predetermined range of the delivery destination (OP102: NO), the process in OP102 is repeated. Furthermore, for example, in the case where the scheduled delivery time is passed without the vehicle 2 being detected to be present within the predetermined range of the delivery destination, the process illustrated in FIG. 8A may be ended.

In OP103, the delivery control unit 12 transmits a notification instruction regarding a delivery vehicle approach notification to the in-house device 3 at the delivery destination. The contact information of the in-house device 3 is acquired from the user information management table (FIG. 6), for example. When the notification instruction regarding a delivery vehicle approach notification is received from the center server 1, the in-house device 3 determines a presence/absence state of a recipient on the basis of an operation state of an output device inside the house, for example, and in the case where the output device is not operating, the in-house device 3 may determine “absence”, and may notify the center server 1 to the effect without issuing a notification. In the case where the output device inside the house is operating, the in-house device 3 outputs the delivery vehicle approach notification from the output device.

In OP104, the delivery control unit 12 determines whether the vehicle 2 arrived at the delivery destination, on the basis of the position information of the vehicle 2. Additionally, in the determination, affirmative determination may be made when a distance between the vehicle 2 and the delivery destination falls below 3 to 5 meters, even if the position information of the vehicle 2 does not strictly indicate the position of the delivery destination. In the case where the vehicle 2 is determined to have arrived at the delivery destination (OP104: YES), the process proceeds to OP105. In the case where the vehicle 2 is determined not to have arrived at the delivery destination (OP104: NO), the process in OP104 is repeated. Furthermore, for example, in the case where the scheduled delivery time is passed without the vehicle 2 being determined to have arrived at the delivery destination, the process illustrated in FIG. 8A may be ended.

In OP105, the delivery control unit 12 determines whether the scheduled delivery time is reached. In the case where the scheduled delivery time is reached (OP105: YES), the process proceeds to OP106. In the case where the scheduled delivery time is not reached (OP105: NO), the process proceeds to OP104. In the case where the scheduled delivery time for the target delivery in the delivery information management table is specified by a time slot, it is also possible to determine whether the time slot is reached.

In OP106, the delivery control unit 12 transmits a notification instruction regarding a delivery vehicle arrival notification to the in-house device 3 at the delivery destination. When the notification instruction regarding a delivery vehicle arrival notification is received from the center server 1, the in-house device 3 outputs the delivery vehicle arrival notification from the output device.

Next, OP201 in FIG. 8B is performed, and in OP201, the delivery control unit 12 determines whether a delivery completion notification is received from the vehicle 2. In the case where the delivery completion notification is received from the vehicle 2 (OP201: YES), completion of the delivery is indicated, and the process illustrated in FIG. 8B is ended. In the case where the delivery completion notification is not received from the vehicle 2 (OP201: NO), the process proceeds to OP202.

In OP202, the delivery control unit 12 determines whether a predetermined time has passed since transmission of the delivery vehicle arrival notification to the in-house device 3 at the delivery destination. The predetermined time used in the determination in OP202 may be arbitrarily set between 3 and 10 minutes by the administrator of the delivery system 100, for example. In the case where the predetermined time has passed since transmission of the delivery vehicle arrival notification to the in-house device 3 at the delivery destination (OP202: YES), the process proceeds to OP203. In the case where the predetermined time has not passed since transmission of the delivery vehicle arrival notification to the in-house device 3 at the delivery destination (OP202: NO), the process proceeds to OP201.

In OP203, because the predetermined time has passed since transmission of the delivery vehicle arrival notification to the in-house device 3 at the delivery destination, the delivery control unit 12 transmits, to the vehicle 2, an instruction to start charging. When the instruction to start charging is received from the center server 1, the vehicle 2 searches for a power supply device 31 in the periphery, and starts charging from the power supply device 31.

In OP204, the delivery control unit 12 again determines whether the delivery completion notification is received from the vehicle 2. In the case where the delivery completion notification is received from the vehicle 2 (OP204: YES), the process proceeds to OP206. In the case where the delivery completion notification is not received from the vehicle 2 (OP204: NO), the process proceeds to OP205.

In OP205, the delivery control unit 12 determines whether a predetermined time has passed since transmission, to the vehicle 2, of the instruction to start charging. The predetermined time used in the determination in OP205 may be arbitrarily set between 10 and 30 minutes by the administrator of the delivery system, for example. In the case where the predetermined time has passed since transmission, to the vehicle 2, of the instruction to start charging (OP205: YES), the process proceeds to OP206. In the case where the predetermined time has not passed since transmission, to the vehicle 2, of the instruction to start charging (OP205: NO), the process proceeds to OP204.

In OP206, the delivery control unit 12 transmits, to the vehicle 2, an instruction to stop charging. In OP207, the delivery control unit 12 calculates an electricity fee for charging the vehicle 2. Calculation of the electricity fee may be performed using common criterion for all users, for example, or information about an electricity contract may be acquired from a user in advance, and an electricity fee for charging the vehicle 2 that is closer to the actual electricity fee may be calculated on the basis of the information.

In OP208, the delivery control unit 12 gives, to the user who is the recipient at the delivery destination, an incentive according to the electricity fee calculated in OP207. The incentive that is given is recorded in the user information management table, for example. Then, the process illustrated in FIG. 8B is ended.

Additionally, in the case where the user who is the recipient does not wish to receive the service provided by the delivery system 100 regarding the delivery vehicle approach notification, and is not registered in the user information management table, the processes in FIGS. 8A and 8B are not performed. Furthermore, a response may be acquired from the in-house device 3 or the vehicle 2 in response to the instruction to the in-house device 3 or the vehicle 2 in OP103, OP106, OP203, or OP206. Moreover, in the case where the instruction to start charging is received from the center server 1, if the power supply device 31 is not detected, the vehicle 2 may notify the center server 1 to the effect, and the center server 1 may grasp that the vehicle 2 is not charged, and not give an incentive to the user who is the recipient.

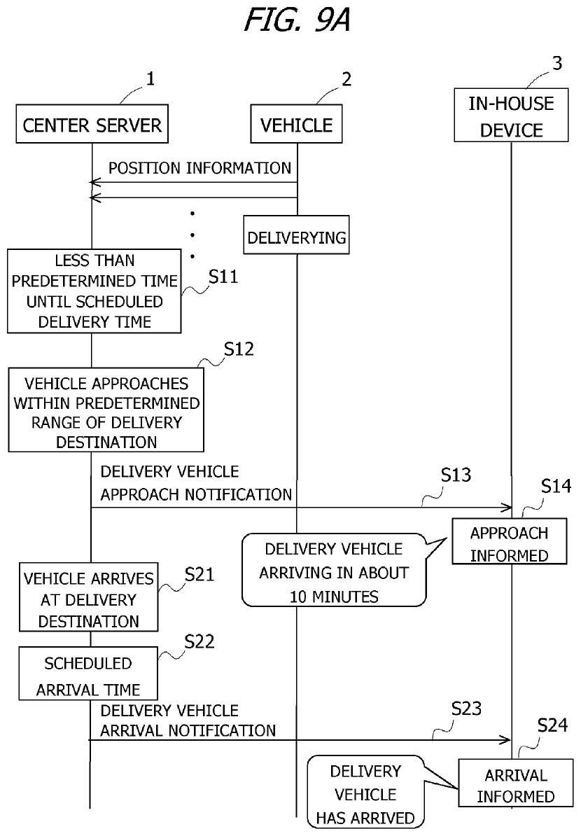

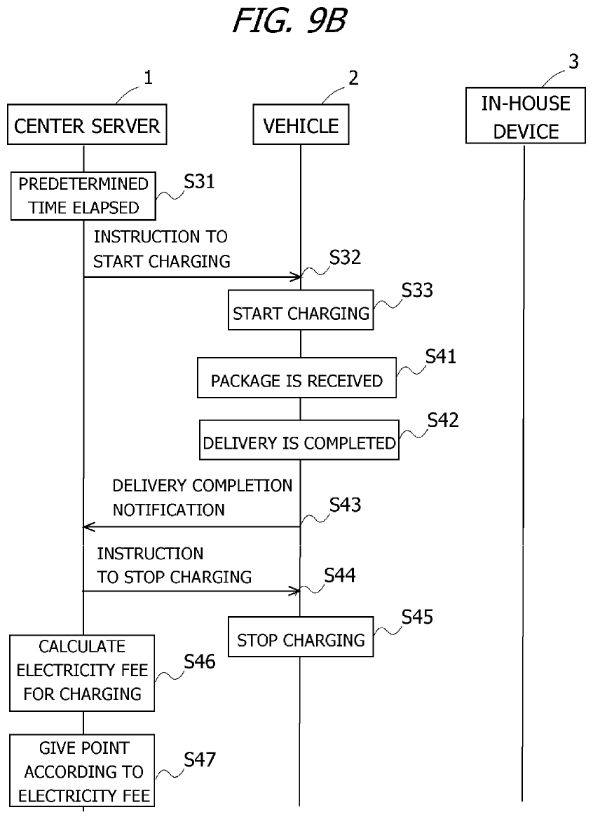

FIGS. 9A and 9B are diagrams illustrating an example of a sequence of processes by the delivery system 100. In FIG. 9A, the vehicle 2 starts delivery by receiving a delivery request from the center server 1, and transmits the position information to the center server 1 every predetermined period. The recipient of a package that is delivered by the vehicle 2 is a user who wishes to receive the service provided by the delivery system 100, and who is registered as a user in the delivery system 100.

In S11, the center server 1 detects that the time until the scheduled delivery time of the vehicle 2 has fallen below a predetermined time (FIG. 8A, OP101: YES). In S12, the center server 1 detects that the vehicle 2 approached within a predetermined range of the delivery destination, on the basis of the position information of the vehicle 2 (FIG. 8A, OP102: YES). In S13, the center server 1 transmits the notification instruction regarding a delivery vehicle approach notification to the in-house device 3 at the delivery destination (FIG. 8A, OP103).

In S14, the in-house device 3 at the delivery destination causes the output device inside the house at the delivery destination to output the delivery vehicle approach notification. For example, a smart speaker as the in-house device 3 outputs, from a speaker of the smart speaker as the output device, a voice message such as “delivery vehicle arriving in about 10 minutes”. The recipient at the delivery destination who is preparing to go out may thereby decide to stay at home until arrival of the delivery vehicle or may get dressed. Additionally, in S14, in the case where absence of the recipient can be determined due, for example, to one of output devices not operating, the in-house device 3 does not have to cause the delivery vehicle approach notification to be output from the output device.

In S21, the center server 1 detects arrival of the vehicle 2 at the delivery destination (FIG. 8A, OP104: YES). In S22, the center server 1 determines that the scheduled delivery time is reached (FIG. 8A, OP105: YES). In S23, the center server 1 transmits, to the in-house device 3 at the delivery destination, the notification instruction regarding a delivery vehicle arrival notification (FIG. 8A, OP106).

In S24, the in-house device 3 at the delivery destination causes the delivery vehicle arrival notification to be output from the output device inside the house at the delivery destination. For example, a smart speaker as the in-house device 3 outputs, from a speaker of the smart speaker as the output device, a voice message such as “delivery vehicle has arrived”. The recipient at the delivery destination may thus head to receive the package from the vehicle 2 which has arrived in front of home.

In S31 in FIG. 9B, for example, if a predetermined time passes without the recipient appearing from the house at the delivery destination, the center server 1 detects that a predetermined time passed since transmission of the notification instruction regarding the delivery vehicle arrival notification (FIG. 8B, OP201: NO, OP202: YES). In S32, the center server 1 transmits, to the vehicle 2, an instruction to start charging (FIG. 8B, OP203). In S33, the vehicle 2 receives the instruction to start charging from the center server 1, searches for a power supply device 31 at the delivery destination, and starts charging from the power supply device 31.

In S41, the recipient at the delivery destination receives the package from the vehicle 2. In S42, the recipient at the delivery destination inputs delivery completion on the display 207 with a touch panel of the vehicle 2, for example. In S43, the vehicle 2 transmits a notification regarding delivery completion to the center server 1, and the center server 1 receives the notification regarding delivery completion from the vehicle 2 (FIG. 8B, OP204: YES).

In S44, the center server 1 transmits, to the vehicle 2, an instruction to stop charging (FIG. 8B, OP206). In S45, the vehicle 2 receives the instruction to stop charging from the center server 1, and stops charging from the power supply device 31.

In S45, the center server 1 calculates the electricity fee for charging the vehicle 2 (FIG. 8B, OP207). In S46, the center server 1 gives an incentive according to the calculated electricity fee to the recipient at the delivery destination (FIG. 8B, OP208). The center server 1 may then notify the in-house device 3 at the delivery destination or a user terminal of the recipient that an incentive has been given.

### Advantages and Effects of First Embodiment

In the first embodiment, when the vehicle 2 delivering a package approaches the delivery destination, the delivery vehicle approach notification is issued at the delivery destination through the in-house device 3 at the delivery destination. A recipient at the delivery destination may thus easily prepare to receive the package. Furthermore, the package may be smoothly handed over to the recipient upon arrival of the vehicle 2 at the delivery destination, and a delivery efficiency may be increased. Furthermore, occurrence of re-deliveries due to the recipient not being able to come to the door to receive delivery in spite of being at home, or due to the recipient leaving home just before arrival of the vehicle 2 may be suppressed, for example.

Furthermore, in the first embodiment, when the vehicle 2 arrives at the delivery destination, the delivery vehicle arrival notification is issued at the delivery destination through the in-house device 3 at the delivery destination. The recipient at the delivery destination may thereby swiftly head to receive the package upon arrival of the vehicle 2, and handing over of the package may be smoothly performed. This is more advantageous in the case where the vehicle 2 is an unmanned autonomous vehicle.

Moreover, in the first embodiment, in the case where a package is not handed over for a predetermined time after transmission of the notification instruction regarding the delivery vehicle arrival notification from the center server 1, charging of the vehicle 2 is started using the power supply device 31 at the delivery destination. A time of waiting for the recipient at the delivery destination may thus be effectively used, and also, the vehicle 2 may be enabled to operate longer.

Moreover, in the first embodiment, in the case where the vehicle 2 is charged at the delivery destination, an incentive according to the electricity fee for charging is given to the user at the delivery destination. A user who is possibly a recipient at the delivery destination may thus be encouraged to allow the vehicle 2 to use the power supply device 31 at home.

### Other Embodiments

The embodiment described above is an example, and the present disclosure may be changed and carried out as appropriate without departing from the gist of the present disclosure.

In the first embodiment, the center server 1 controls the vehicle 2 and the in-house device 3, but the vehicle 2 itself may alternatively grasp a positional relationship to the delivery destination, and may transmit the notification instructions regarding the delivery vehicle approach notification and the delivery vehicle arrival notification to the in-house device 3. In this case, the vehicle 2 and the in-house device 3 may directly communicate with each other according to a predetermined wireless communication method, instead of through the center server 1. Moreover, the vehicle 2 itself may determine start and stop of charging at the delivery destination. In this case, the processes are performed by the CPU 201 of the vehicle 2, for example. In this case, the CPU 201 of the vehicle 2 is an example of the “processor”.

In the first embodiment, the vehicle 2 is assumed to be an autonomous vehicle, but the vehicle 2 may alternatively be a vehicle that travels by being driven by a person. Furthermore, the vehicle 2 is assumed to be an electric vehicle, but the vehicle 2 may alternatively be an engine-driven vehicle that uses gasoline as fuel. In the case where the vehicle 2 is an engine-driven vehicle that uses gasoline as fuel, the charging process at the delivery destination is not performed.

The processes and means described in the present disclosure may be freely combined to the extent that no technical conflict exists.

A process which is described to be performed by one device may be performed divided among a plurality of devices. Processes described to be performed by different devices may be performed by one device. Each function is to be implemented by which hardware component (server component) in a computer system may be flexibly changed.

The present disclosure may also be implemented by supplying a computer program for implementing a function described in the embodiment above to a computer, and by reading and executing the program by at least one processor of the computer. Such a computer program may be provided to a computer by a non-transitory computer-readable storage medium which is connectable to a system bus of a computer, or may be provided to a computer through a network. The non-transitory computer-readable storage medium may be any type of disk such as a magnetic disk (floppy (registered trademark) disk, a hard disk drive (HDD), etc.), an optical disk (CD-ROM, DVD disk, Blu-ray disk, etc.), a read only memory (ROM), a random access memory (RAM), an EPROM, an EEPROM, a magnetic card, a flash memory, an optical card, and any type of medium which is suitable for storing electronic instructions.

What is claimed is:

1. An information processing system comprising:
a vehicle that delivers a package to a predetermined delivery destination;
an in-house device installed inside a house at the predetermined delivery destination, the in-house device being capable of controlling an output device at the predetermined destination; and
a processor configured to:
acquire position information of the vehicle, and
cause the in-house device to issue notification of approach of the vehicle through the output device, in a case where the vehicle approaches within a predetermined range of the predetermined delivery destination.

2. The information processing system according to claim 1, wherein the processor is further configured to cause the in-house device to issue notification of arrival of the vehicle through the output device, in a case where the vehicle arrives at the predetermined delivery destination.

3. The information processing system according to claim 1, wherein
the vehicle is an electric vehicle, and
the vehicle starts charging from a power supply device provided at the predetermined delivery destination, in a case where handing over of the package is not performed even after a lapse of a predetermined time after arrival of the vehicle at the predetermined delivery destination.

4. The information processing system according to claim 3, wherein the processor is configured to give a predetermined incentive to a user associated with the predetermined delivery destination, after charging of the vehicle is ended.

5. An information processing method comprising:
acquiring position information of a vehicle that delivers a package to a predetermined delivery destination; and
causing an in-house device, installed inside a house at the predetermined delivery destination and capable of controlling an output device at the predetermined delivery destination, to issue notification of approach of the vehicle through the output device, in a case where the vehicle approaches within a predetermined range of the predetermined delivery destination.
